(19) United States
(12) Patent Application Publication
(10) Pub. No.: US 2013/0032185 A1
(43) Pub. Date: Feb. 7, 2013

(54) CANE TIP AND CANE

(71) Applicant: Shinya SATO, Nagasaki-shi (JP)

(72) Inventor: Shinya SATO, Nagasaki-shi (JP)

(21) Appl. No.: 13/562,781

(22) Filed: Jul. 31, 2012

(30) Foreign Application Priority Data
Aug. 1, 2011 (JP) 2011-168133
Feb. 21, 2012 (JP) 2012-035370

(51) Int. Cl. A45B 9/04; A61H 3/02; A45B 7/00

(52) U.S. Cl. 135/68; 135/86; 135/77

(57) ABSTRACT

Provided is a cane tip which is difficult to slip, exhibiting excellent shock absorbing properties when contacted with the ground; with which the cane tip will not stick in a crevice of a stone pavement; and further, with which the influence of the supporting surface inclination can be suppressed, whereby the walking stability is assured also for an aged user; and which is also well suited for use in rehabilitation. Cane tip has a cane tip main body with leg segments radially extending from a central part, being arranged in an overall shape substantially analogous to that of the five petals of a five-petaled flower, the central part and each leg segment having an elastic structure part exerting an elastic action, a bolt inserting hole in the central part of the elastic structure part, and a bolt inserted into this bolt hole and protruded from that central part.

### BACKGROUND OF THE INVENTION

1. Field of the Invention

The present invention relates to a cane tip and a cane which are difficult to slip, exhibiting excellent shock absorbing properties when contacted with the ground, or the like; with which the cane tip will not stick in a crevice of a stone pavement, or the like; and further, with which, even when the supporting surface has an inclination, the influence of the surface inclination can be suppressed, whereby the walking stability is assured for any user, including an aged one; and which is also well suited for use in rehabilitation.

2. Description of the Related Art

Generally, when aged persons whose legs and loins have become weak, and whose arm and grip strengths have also been decreased, people with walking disabilities, patients undergoing rehabilitation, and the like, make a walk, they use a cane for walking assistance that is selected from those having various structures.

The use of a cane for walking assistance allows the aged, and the like, to lighten the load imposed on the legs and loins in walking, and to more easily find a body balance in walking.

And, as this type of canes, single walking sticks (T-shaped canes) made of, for example, a light alloy, such as aluminum, or the like, multi-leg canes (four-legged canes), Lofstrand crutches (F-shaped canes), crutches (axilla supporting crutches), and the like, are being used.

A typical example of structure of a cane is such that an elastic member (a rubber cane tip) made of a rubber material, or the like, for absorbing a shock applied to the cane when contacted with the ground is mounted to a cane tip which is provided at the lower end of a cane main body in the shape of a bar.

However, with a cane having such a structure, the elastic member constituting the cane tip is generally small in diameter or size, presenting problems that, when an aged person whose arm and grip strengths are poor, or the like, makes a walk, while applying a moment of force from the hand gripping the upper portion of the cane main body in the shape of a bar, using the cane tip as a fulcrum, the cane tip can be easy to slip under such unfavorable road conditions as those on a rainy day, and the cane tip can stick in, for example, a crevice on a road surface of a stone pavement structure, and thus the walking stability is not assured.

In order to solve such gait instability problems, hospitals, and the like, cause walkers having a symptom of, for example, lower body paralysis, leg amputation, shoulder paralysis, or the like, to use a four-legged cane, Lofstrand crutches, or the like, in walking.

However, with the four-legged cane, for example, the elastic member is mounted in the lower end portion of the four ground contact legs, and therefore, unless the entire four-legged cane is brought up in a direction normal to the ground surface, and then lowered straight to contact the four ground contact legs with the ground surface in walking, it is difficult to obtain the walking stability, thereby the four-legged cane involves a problem that it is extremely difficult to be used by an aged person whose arm and grip strengths are poor, or the like, being an inconvenient walking aid.

In Patent Document 1, there is proposed a cane, comprising: a ferrule (cane tip) including a flat plate, such as a metal plate, or the like, having a rigidity to some extent; a slip stop member formed of rubber, or the like, which is attached to the bottom face thereof, also serving as a cushion; and a shaft member formed to be protruded upward from a central portion of the flat plate, the shaft member being connected to the lower end of a foot piece constituting the cane main body, using a universal joint, coil spring, and cover cylinder body.

However, with the ferrule in the cane of Patent Document 1, the flat plate constituting the ferrule has a wide appropriate area than the cross-sectional area of the foot piece, however, the geometry is of a normal circular disk, thereby it being estimated that sufficient walking stability is not always assured, and the structure of the ferrule for mounting and removing to/from the lower end of the foot piece constituting the cane main body is too complex to allow easy mounting and removing, it being estimated that the replacement use of the ferrule at the time of rehabilitation is not considered.
Patent Document 1: Japanese Utility Model Registration Publication No. 3131874

The problem to be solved by the present invention is that no cane tip and cane are available which are difficult to slip, exhibiting excellent shock absorbing properties when contacted with the ground, or the like; with which the cane tip will not stick in a crevice of a stone pavement, or the like; further, with which, even when the supporting surface has an inclination, the influence of the surface inclination can be suppressed, whereby the walking stability is assured for any user, including an aged one; with which, in accordance with the degree of physical strength of the user, such as arm strength, grip strength, or the like, the cane tip can be easily replaced at any time, and the slip stop function and the suction function are provided, whereby the walking stability of the aged, and the like, can be further improved; and which is thus well suited for use by the aged, and the like, and in rehabilitation.

### SUMMARY OF THE INVENTION

The cane tip in accordance with the present invention provides, as a most important feature, that it comprises: a cane tip main body including a plurality of leg segments radially extending outwards from a central part thereof, the central part and each of the leg segments being provided with an elastic structure part exerting an elastic action; and a mounting part provided in the central part of the cane tip main body for making the cane tip main body mountable and removable to/from a tip part of a cane main body.

In accordance with aspects of the invention as stated in claims 1 to 4, there can be realized and provided a novel cane tip allowing configuring of a novel cane which is difficult to slip, exhibiting excellent shock absorbing properties when contacted with the ground, or the like; with which the cane tip will not stick in a crevice of a stone pavement, or the like; further, with which, even when the supporting surface has an inclination, the influence of the surface inclination can be suppressed, whereby the walking stability is assured for any user, including an aged one; with which, in accordance with the degree of physical strength of the user, such as arm strength, grip strength, or the like, the cane tip can be easily replaced at any time; and which is thus well suited for use in rehabilitation.

In accordance with an aspect of the invention as stated in claim 5, there can be realized and provided an elastic structure part allowing the advantages of the novel cane tip of the aspect of the invention as stated in any of claims 1 to 4 to be obtained, the elastic structure part being formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface.

In accordance with an aspect of the invention as stated in claim 6, there can be realized and provided a novel cane tip allowing configuring of a novel cane which is difficult to slip, exhibiting excellent shock absorbing properties when contacted with the ground, or the like; with which the cane tip will not stick in a crevice of a stone pavement, or the like; further, with which, even when the supporting surface has an inclination, the influence of the surface inclination can be suppressed, whereby the walking stability is assured for any user, including an aged one; with which, in accordance with the degree of physical strength of the user, such as arm strength, grip strength, or the like, the cane tip can be easily replaced at any time; and which is thus well suited for use in rehabilitation,

the cane tip, comprising: a cane tip main body including six leg segments constituted by five longer leg segments of the same length and one shorter leg segment formed shorter than the longer leg segment, and radially extending outwards from a central part thereof, or including a plurality of leg segments arranged in an overall shape substantially analogous to that of the five petals of a five-petaled flower, the five legs of the five-legged starfish, the six legs of the six-legged starfish, or the four toes of a bird, and radially extending outwards from a central part thereof, the central part and each leg segment having an elastic structure part exerting an elastic action; and a mounting part including a bolt inserting hole provided in the central part of the elastic structure part, and a bolt inserted into this bolt inserting hole and protruded from the central part of the elastic structure part.

In accordance with an aspect of the invention as stated in claim 7, there can be realized and provided an elastic structure part allowing the advantages of the novel cane tip of the aspect of the invention as stated in any of claims 1 to 6 to be obtained, the cane tip main body being in the shape of a profiled flat disk or in the shape of a reversed umbrella, substantially the central portion of the cane tip main body forming the apex thereof.

In accordance with an aspect of the invention as stated in claim 8, there can be realized and provided an elastic structure part allowing the advantages of a novel cane tip of the invention stated in any of claims 1 to 7 to be obtained, the elastic structure part being formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface; and the mounting part having a bolt inserting hole penetrating through the central part of the plate-shaped rubber member, plate-shaped glass carbon member, and plate-shaped wood member, and a bolt inserted into the bolt inserting hole to be anchored, a thread part thereof being protruded from the central part of the elastic structure part to be screwed or unscrewed into/from a receiving screw part provided inside of the tip part of the cane main body for making the cane tip main body mountable and removable to/from the tip part of the cane main body.

In accordance with aspects of the invention as stated in claims 9 to 12, there can be realized and provided a novel cane, using the novel cane tip of the aspect of the invention as stated in any of claims 1 to 4, which is difficult to slip, exhibiting excellent shock absorbing properties when contacted with the ground, or the like; with which the cane tip will not stick in a crevice of a stone pavement, or the like; further, with which, even when the supporting surface has an inclination, the influence of the surface inclination can be suppressed, whereby the walking stability is assured for any user, including an aged one; with which, in accordance with the degree of physical strength of the user, such as arm strength, grip strength, or the like, the cane tip can be easily replaced at any time; and which is thus well suited for use in rehabilitation.

In accordance with an aspect of the invention as stated in claim 13, there can be realized and provided an elastic structure part allowing the advantages of the novel cane tip constituting the novel cane of the invention stated in any of claims 9 to 12 to be obtained, the elastic structure part being formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface.

In accordance with an aspect of the invention as stated in claim 14, there can be realized and provided an elastic structure part allowing the advantages of the novel cane tip constituting the novel cane of the aspect of the invention as stated in any of claims 9 to 12 to be obtained, the cane tip main body being in the shape of a profiled flat disk or in the shape of a reversed umbrella, substantially the central portion of the cane tip main body forming the apex thereof.

In accordance with an aspect of the invention as stated in claim 15, there can be realized and provided a novel cane, using the novel cane tip of the aspect of the invention as stated in claim 6, which is difficult to slip, exhibiting excellent shock absorbing properties when contacted with the ground, or the like; with which the cane tip will not stick in a crevice of a stone pavement, or the like; further, with which, even when the supporting surface has an inclination, the influence of the surface inclination can be suppressed, whereby the walking stability is assured for any user, including an aged one; with which, in accordance with the degree of physical strength of the user, such as arm strength, grip strength, or the like, the cane tip can be easily replaced at any time; and which is thus well suited for use in rehabilitation.

In accordance with an aspect of the invention as stated in claim 16, there can be realized and provided an elastic structure part allowing the advantages of the novel cane tip constituting the novel cane of the aspect of the invention as stated in any of claims 9 to 15 to be obtained, the elastic structure part being formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface; and the mounting part has a bolt inserting hole penetrating through the central part of the plate-shaped rubber member, plate-shaped glass carbon member, and plate-shaped wood member, and a bolt inserted into the bolt inserting hole to be anchored, a thread part thereof being protruded from the central part of the elastic structure part to be screwed or unscrewed into/from a receiving screw part provided inside of the tip part of the cane main body for making the cane tip main body mountable and removable to/from the tip part of the cane main body.

In accordance with an aspect of the invention as stated in claim 17, there can be realized and provided a novel cane tip which, comprising: a cane accommodating cylinder part in the shape of a truncated cone for accommodating a tip part of a cane main body; a ground contacting body part provided integrally with the cane accommodating cylinder part, being located thereunder, such that the cane accommodating cylinder part is located biased towards one side, a plurality of segments being protruded to be arranged distributed in the outer edge portion of the ground contacting body part, the entire bottom face thereof being made flat; and recess grooves for slip stop provided in the bottom face of at least one leg segment among the plurality of leg segments that is located on the same side as that on which the cane accommodating cylinder part is located biased, allows the entire bottom face of the ground contacting body part to be contacted with the supporting surface, and the recess grooves provided in at least one leg segment to exert the slip stop effect, whereby the walking stability is assured for any user, including an aged person.

In accordance with an aspect of the invention as stated in claim 18, there can be realized and provided a novel cane tip which, comprising: a cane accommodating cylinder part in the shape of a truncated cone for accommodating a tip part of a cane main body; a ground contacting body part exhibiting substantially a shoe-like geometry, being provided integrally with the cane accommodating cylinder part such that the cane accommodating cylinder part is located biased toward a rear portion of the ground contacting body part likened to the heel portion of a shoe, having leg segments arranged distributed in the outer edge portion of the ground contacting body part, the leg segments including a rear leg segment protruded toward the rear portion of the ground contacting body part likened to the heel portion of a shoe, a side leg segment protruded toward a side of the ground contacting body part, and an oblique leg segment protruded aslant forward on the front part side of the ground contacting body part, and the entire bottom face thereof being made flat; and recess grooves for slip stop provided in the respective bottom faces of the rear leg segment, side leg segment, and oblique leg segment, allows the entire bottom face of the ground contacting body part to be contacted with the supporting surface, and the recess grooves provided in the leg segments to exert the slip stop effect over the entire area of the cane tip bottom face, whereby a more excellent walking stability is assured for any user, including an aged person.

In accordance with an aspect of the invention as stated in claim 19, there can be realized and provided a novel cane tip which, comprising, in addition to the configuration similar to that of the aspect of the invention as stated in claim 18, a recess part exerting the suction function, being provided inward from the bottom face of the ground contacting body part, allows the advantages similar to those of the aspect of the invention as stated in claim 18 to be obtained, and in addition, in the case where the supporting surface is smooth, when the bottom face around the recess part is tightly contacted with the smooth supporting surface, the same function as that of a suction cup to be exerted by the recess part, whereby the walking stability of the user can be improved.

In accordance with an aspect of the invention as stated in claim 20, there can be realized and provided an elastic structure part allowing the advantages of the novel cane tip of the aspect of the invention as stated in any of claims 17 to 19 to be obtained, being based on the good sense of use as a result of absorption of the shocks at the time of contact with the supporting surface, the cane accommodating cylinder part and ground contacting body part constituting the cane tip being comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

In accordance with an aspect of the invention as stated in claim 21 there can be realized and provided a novel cane which, comprising: a cane main body; a cane accommodating cylinder part in the shape of a truncated cone for accommodating a tip part of the cane main body; a ground contacting body part provided integrally with the cane accommodating cylinder part, being located thereunder, such that the cane accommodating cylinder part is located biased towards one side, a plurality of segments being protruded to be arranged distributed in the outer edge portion thereof, the entire bottom face thereof being made flat; and recess grooves for slip stop provided in the bottom face of at least one leg segment among the plurality of leg segments that is located on the same side as that on which the cane accommodating cylinder part is located biased, allows the entire bottom face of the ground contacting body part to be contacted with the supporting surface, and the recess grooves provided in at least one leg segment to exert the slip stop effect, whereby the walking stability is assured for any user, including an aged person.

In accordance with an aspect of the invention as stated in claim 22 there can be realized and provided a novel cane which, comprising: a cane main body; a cane accommodating cylinder part in the shape of a truncated cone for accommodating a tip part of the cane main body; a ground contacting body part exhibiting substantially a shoe-like geometry, being provided integrally with the cane accommodating cylinder part such that the cane accommodating cylinder part is located biased toward a rear portion of the ground contacting body part likened to the heel portion of a shoe, having leg segments arranged distributed in the outer edge portion thereof, the leg segments including a rear leg segment protruded toward the rear portion thereof likened to the heel portion of a shoe, a side leg segment protruded toward a side of thereof, and an oblique leg segment protruded aslant forward on the front part side of thereof, and the entire bottom face thereof being made flat; and recess grooves for slip stop provided in the respective bottom faces of the rear leg segment, side leg segment, and oblique leg segment, allows the entire bottom face of the ground contacting body part to be contacted with the supporting surface, and the recess grooves provided in the leg segments to exert the slip stop effect over the entire area of the cane tip bottom face, whereby a more excellent walking stability is assured for any user, including an aged person.

In accordance with an aspect of the invention as stated in claim 23 there can be realized and provided a novel cane which, comprising: a cane main body; a cane accommodating cylinder part in the shape of a truncated cone for accommodating a tip part of the cane main body; a ground contacting body part exhibiting substantially a shoe-like geometry, being provided integrally with the cane accommodating cylinder part such that the cane accommodating cylinder part is located biased toward a rear portion of the ground contacting body part likened to the heel portion of a shoe, having five leg segments arranged distributed in the outer edge portion thereof, the leg segments including a rear leg segment protruded toward the rear portion thereof likened to the heel portion of a shoe, two side leg segments protruded toward both sides thereof, and two oblique leg segments protruded aslant rightward and leftward on the front part side thereof, the overall shape of the leg segments being substantially analogous to that of the toes of a bird, and the entire bottom face thereof being made flat; recess grooves for slip stop provided in the respective bottom faces of the rear leg segment, side leg segment, and oblique leg segment; and a recess part exerting the suction function, being provided inward from the bottom face of the ground contacting body part, allows the advantages similar to those of the aspect of the invention as stated in claim 22 to be obtained, and in addition, in the case where the supporting surface is smooth, when the bottom face around the recess part is tightly contacted with the smooth supporting surface, the same function as that of a suction cup to be exerted by the recess part, whereby the walking stability of the user can be improved.

In accordance with an aspect of the invention as stated in claim 24, there can be realized and provided an elastic structure part allowing the advantages of the novel cane tip of the aspect of the invention as stated in any of claims 21 to 23 to be obtained, being based on the good sense of use as a result of absorption of the shocks at the time of contact with the supporting surface, the cane accommodating cylinder part and ground contacting body part constituting the cane tip being comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

In accordance with an aspect of the invention as stated in claim 25 there can be realized and provided a novel cane allowing the same effects as those of the aspect of the invention as stated in any of claims 21 to 24 to be obtained, the cane main body constituting the cane being in a form selected by the user from those of a single walking stick, a multi-leg cane, Lofstrand crutches, a folding cane, and crutches.

### BRIEF DESCRIPTION OF THE DRAWINGS

FIG. 1 is a schematic front view illustrating a cane loaded with a cane tip in accordance with the embodiment 1 of the present invention;

FIG. 2 is a schematic enlarged front view of the cane tip in accordance with the embodiment 1;

FIG. 3 is a schematic enlarged partial sectional view illustrating the cane tip and cane in accordance with the embodiment 1;

FIG. 4 is a schematic enlarged top view of the cane tip in accordance with the embodiment 1;

FIG. 5 is a schematic enlarged top view of a modification of the cane tip in accordance with the embodiment 1;

FIG. 6 is a schematic enlarged top view of the cane tip in accordance with the embodiment 2 of the present invention;

FIG. 7 is a schematic enlarged top view of the cane tip in accordance with the embodiment 2 in the case where the maximum outside dimension is 100 mm;

FIG. 8 is a schematic enlarged top view of the cane tip in accordance with the embodiment 2 in the case where the maximum outside dimension is 140 mm;

FIG. 9 is a schematic enlarged top view of the cane tip in accordance with the embodiment 2 in the case where the maximum outside dimension is 180 mm;

FIG. 10 is a schematic enlarged top view of a modification of the cane tip in accordance with the embodiment 2;

FIG. 11 is a schematic enlarged top view of the cane tip in accordance with the embodiment 3 of the present invention;

FIG. 12 is a schematic enlarged top view of the cane tip in accordance with the embodiment 4 of the present invention;

FIG. 13 is a schematic enlarged front view of the cane tip in accordance with the embodiment 5 of the present invention;

FIG. 14 a schematic enlarged top view of the cane tip in accordance with the embodiment 5 of the present invention;

FIG. 15 a schematic enlarged bottom view of the cane tip in accordance with the embodiment 5 of the present invention; and

FIG. 16 is a schematic front view illustrating a cane loaded with the cane tip in accordance with the embodiment 5 of the present invention.

### DETAILED DESCRIPTION OF THE PREFERRED EMBODIMENTS

The present invention has achieved the purpose of providing a cane tip allowing configuring a cane which is difficult to slip, exhibiting excellent shock absorbing properties when contacted with the ground, or the like; with which the cane tip will not stick in a crevice of a stone pavement, or the like; further, with which, even when the supporting surface has an inclination, the influence of the surface inclination can be suppressed, whereby the walking stability is assured for any user, including an aged one; with which, in accordance with the degree of physical strength of the user, such as arm strength, grip strength, or the like, the cane tip can be easily replaced at any time; and which is thus well suited for use in rehabilitation,

by using a cane tip, comprising: a cane tip main body including six leg segments constituted by five longer leg segments of the same length and one shorter leg segment formed shorter than the longer leg segment, and radially extending outwards from a central part thereof, or including a plurality of leg segments arranged in an overall shape substantially analogous to that of the five petals of a five-petaled flower, the five legs of the five-legged starfish, the six legs of the six-legged starfish, or the four toes of a bird, and radially extending outwards from a central part thereof, the central part and each leg segment having an elastic structure part exerting an elastic action; and a mounting part including a bolt inserting hole provided in the central part of the elastic structure part, and a bolt inserted into this bolt inserting hole and protruded from the central part of the elastic structure part.

Hereinbelow, cane tips and canes in accordance with embodiments of the present invention will be explained in detail with reference to the drawings.

### Embodiment 1

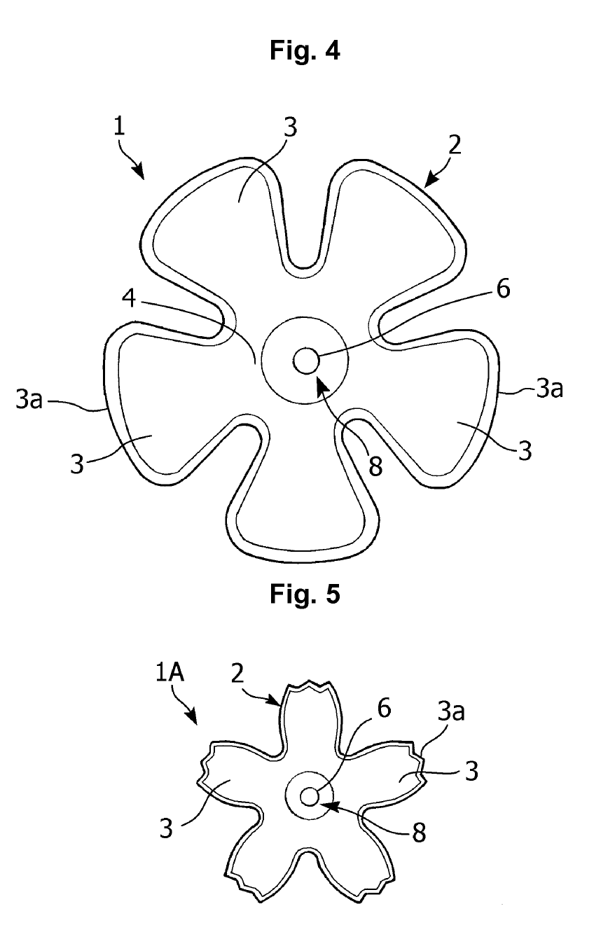

First, with reference to FIG. 1 to FIG. 4, a novel cane tip 1 and a cane 51 in accordance with the present embodiment 1 will be explained.

FIG. 1 shows an example in which the cane tip 1 in accordance with the present embodiment 1 is mounted to a cane main body 52 constituting the cane 51 in the form of a single walking stick, such as a T-shaped cane.

The overall length of the cane 51 in the state in which the cane tip 1 is mounted to the cane main body 52 is in the range of, for example, 700 to 800 mm.

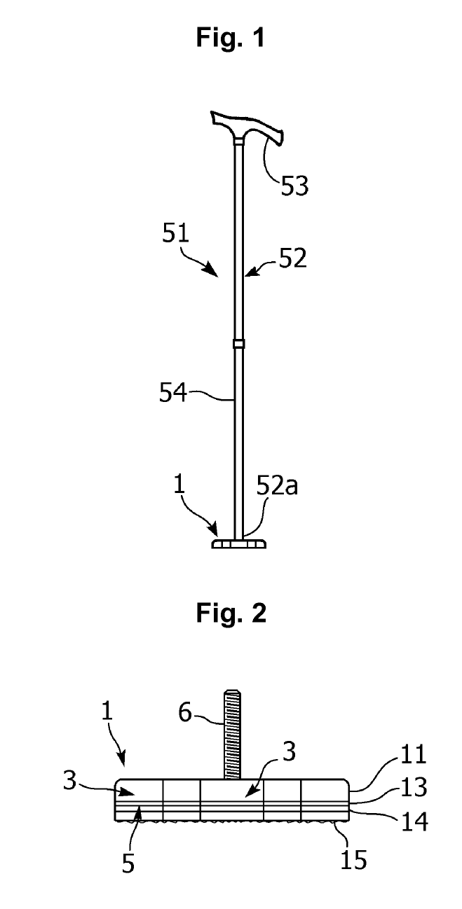

As shown in FIG. 2 to FIG. 4, the cane tip 1 in accordance with the present embodiment 1 is provided with a cane tip main body 2 having leg segments 3 radially extending outwards from a central part 4, being arranged in an overall shape substantially analogous to that of the five petals of a five-petaled flower, the central part 4 and each of the leg segments 3 having an elastic structure part 5 exerting an elastic action, and the cane tip 1 being in the shape of, for example, a profiled flat disk, as a whole, and having a wide area, compared to the cane tip of the conventional cane.

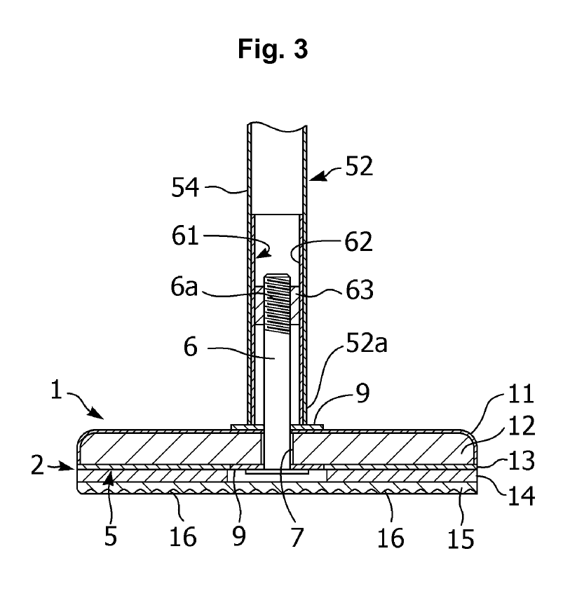

The embodiment shown in FIG. 2 and FIG. 3 is explained with the use of an example in which the cane tip main body 2 is substantially in the shape of a profiled flat disk, however, in the present invention, the shape of the cane tip main body 2 is not limited to that of a profiled flat disk, and the cane tip main body 2 may be in the shape of, for example, a reversed umbrella, substantially the central portion of the cane tip main body 2 forming the apex thereof. In addition, the cane tip main body 2 may be in the shape of, for example, a truncated cone, the central portion of the cane tip main body 2 forming the upper base of the truncated cone.

In addition, the cane tip main body 2 has a mounting part 8 including a bolt 6 and a bolt inserting hole 7 for making this cane tip main body 2 mountable and removable to/from the tip part 52a of the cane main body 52 by screwing or unscrewing the bolt 6.

In the present invention, the mounting and removing structure of the cane tip main body 2 and the tip part 52a of the cane main body 52 may also be implemented by forming a bolt portion in the tip part 52a of the cane main body 52, and providing a bolt inserting hole in the inside of the cane tip main body 2 to allow the bolt portion to be screwed or unscrewed, thereby making the cane tip main body 2 and the cane main body 52 mountable and removable to/from each other.

In FIG. 3, the elastic structure part 5 is formed of a laminated structure constituted by, for example, a plate-shaped wood member 12 formed of, for example, laminated wood covered with a covering layer 11 formed of urethane resin, a plate-shaped glass carbon member 13, a plate-shaped rubber member 14 formed of high-pressure rubber, and a plate-shaped slip stop rubber member 15 formed of high-pressure rubber provided with a concavoconvex part 16 as a lower end face to be contacted with a supporting surface, in this order from the upper portion toward the lower portion to be contacted with a supporting surface.

The elastic structure part 5 is not limited to the illustrated example, and in the present invention, it may also be implemented as such a structure as a single-layer rubber material structure, a laminated structure of a rubber material and a material other than rubber material, or the like.

The bolt inserting hole 7 is provided so as to penetrate through the respective central parts of the rubber member 14, glass carbon member 13, and wood member 12.

As an example of dimensions of the respective parts of the elastic structure part of the cane tip 1 in accordance with the present embodiment, the covering layer 11 has a thickness of 1 mm, the wood member 12 a thickness of 6.5 mm, the glass carbon member 13 a thickness of 1.5 mm, the rubber member 14 a thickness of 3 mm, and the slip stop rubber member 15 a thickness of 3 mm.

Further, when viewed from the top, the elastic structure part 5 has a maximum outside dimension of approx. 100 mm, for example.

The bolt inserting hole 7 constituting the mounting part 8 is configured so as to penetrate through the central part of the plate-shaped rubber member 14, plate-shaped glass carbon member 13, and plate-shaped wood member 12.

The cane 51 is provided with a grip part 53 at the upper end of the cane main body 52 for a user to grip it by hand, having a cylindrical shaft part 54 made of, for example, a stainless steel material and constituting the cane main body 52, and a receiving screw body 61 in the inside of the tip part 52a of the cane main body 52.

The receiving screw body 61 has a cylinder body 62 fitted into the shaft part 54, and a nut 63 concentrically disposed and anchored in the inside of the cylinder body 62.

With the novel cane 51 in accordance with the present embodiment 1, the cane tip 1, as configured above, is mounted to the tip part 52a of the cane main body 52 in the form of a single walking stick, such as a T-shaped cane, so as to be mountable and removable to/from each other, using a bolt 6.

In other words, as shown in FIG. 3, by inserting the bolt 6 into the bolt inserting hole 7, while interposing a plain washer 9, 9 on both sides of the bolt inserting hole 7 provided in the central part of the elastic structure part 5, and screwing this bolt 6 into the nut 63 in the receiving screw body 61 provided in the inside of the tip part 52a of the cane main body 52, the cane tip 1 is integrally mounted to the tip part 52 of the cane main body 52.

In addition, by loosening and removing the bolt 6, the cane tip 1 can be removed from the tip part 52a of the cane main body 52.

In this case, as a structure in which the bolt 6 is inserted into the bolt inserting hole 7 to be anchored, and as exemplified in FIG. 2, the thread part 6a of the bolt 6 is protruded upward from the central part of the elastic structure part 5, it is preferable that the cane tip main body 2 be mountable and removable to/from the cane main body 52 by screwing or unscrewing the thread part 6a into/from the nut 63 in the receiving screw body 61 provided inside of the tip part of the cane main body 52.

Next, the function and the advantages of the novel cane tip 1 and cane 51 in accordance with the present embodiment 1 will be explained.

When, with the cane tip 1 in accordance with the present embodiment 1 being mounted to the cane main body 52 constituting the cane 51, the user grips the grip part 53 with one hand, for example, walking while contacting or leaving the bottom face of the slip stop rubber member 15 of the cane tip 1 with/from a supporting surface, the cane tip 1 is difficult to slip even under such unfavorable road conditions as those on a rainy day, and the cane tip 1 exhibits excellent shock absorbing properties when contacted with the ground, or the like, because the elastic structure part 5 is provided with the slip stop rubber member 15 having the concavoconvex part 16 as a lower end face, and the rubber member 14; and because the cane tip 1 has a wide area as compared to the conventional one, the cane tip 1 will not stick in a crevice of a stone pavement, or the like, whereby the walking stability is assured for any user, including an aged one.

In addition, even if the cane tip 1 is contacted with a supporting surface, such as the ground, and the supporting surface is inclined, the leg segments 3 extending radially, being arranged in an overall shape substantially analogous to that of the five petals of a five-petaled flower, and exerting an elastic action, allow the influence of the surface inclination to be suppressed on the basis of the individual elastic deformation of the slip stop rubber member 15 and the rubber member 14 in each leg segment 3, whereby the walking posture of the walker will not be greatly disturbed, and thus the walking stability is assured for any user, including an aged one.

In other words, according to the present embodiment 1, there can be realized and provided the cane tip 1 and the cane 51 using this cane tip 1, which are difficult to slip, exhibiting excellent shock absorbing properties when contacted with the ground, or the like; with which the cane tip 1 will not stick in a crevice of a stone pavement, or the like; and further, with which, even when the supporting surface has an inclination, the influence of the surface inclination can be suppressed, whereby the walking stability is assured for any user, including an aged one.

FIG. 5 shows a cane tip 1A, which is a modification of the cane tip 1 in accordance with the present embodiment 1. The basic configuration of the cane tip 1A shown in the same figure is identical to that of the cane tip 1 in accordance with the embodiment 1, however, with this cane tip 1A, each of the leg segments 3 arranged in an overall shape substantially analogous to that of the five petals of a five-petaled flower has a protruding end edge 3a which is serrate, having two notches.

Also when, with this modification, i.e., the cane tip 1A, being mounted to the cane main body 52 constituting the cane 51, the user grips the grip part 53 with one hand, for example, walking while contacting or leaving the bottom face of the slip stop rubber member 15 of the cane tip 1A with/from a supporting surface, the same function and advantages as those of the cane tip 1 and cane 51 in the aforementioned embodiment 1 can be obtained.

The cane tip 1 in accordance with the present embodiment 1 and the cane tip 1A, which is a modification of the cane tip 1, are applicable not only to single walking sticks, but also to multi-leg canes, Lofstrand crutches, crutches, folding canes, and the like.

### Embodiment 2

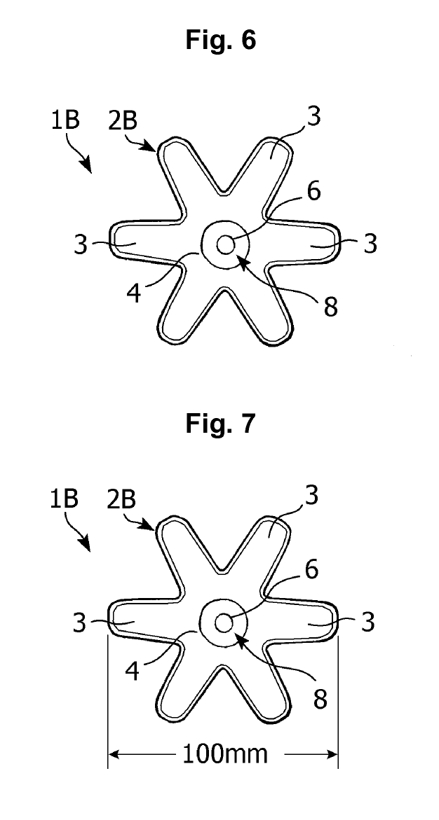

Next, with reference to FIG. 6 to FIG. 9, a novel cane tip 1B in accordance with an embodiment 2 of the present invention will be explained. For the novel cane tip 1B shown in FIG. 6 to FIG. 9, the same elements as those of the novel cane tip 1 in the embodiment 1 will be provided with the same reference numerals, and the detailed explanation of them will be omitted.

As is the case with the embodiment 1, the cane tip 1B shown in FIG. 6 in accordance with the present embodiment 2 is used, being mounted to a cane main body 52, constituting a cane 51 in the form of a single walking stick, such as a T-shaped cane. The cane tip 1B is provided with a cane tip main body 2B having six leg segments 3 arranged in an overall shape substantially analogous to that of, for example, the six legs of a six-legged starfish and radially extending outwards from a central part 4, each being substantially in the shape of a rectangle, when viewed from the top, the central part 4 and the each leg segment 3 having an elastic structure part 5 exerting an elastic action, and the cane tip 1B being in the shape of, for example, a profiled flat disk, as a whole, and having a wide area, as compared to the cane tip of the conventional cane.

As described above in the explanation of the embodiment 1, in the present invention, the shape of the cane tip main body 2 is not limited to that of a profiled flat disk, and the cane tip main body 2 may be in the shape of, for example, a reversed umbrella, substantially the central portion of the cane tip main body 2 forming the apex thereof.

In addition, the cane tip main body 2 may be in the shape of, for example, a truncated cone, the central portion of the cane tip main body 2 forming the upper base of the truncated cone.

As described above, the elastic structure part 5 is not limited to the illustrated example, and in the present invention, it may also be implemented as a structure as a single-layer rubber material structure, a laminated structure of a rubber material and a material other than rubber material, or the like.

Also when, with the cane tip 1B in the embodiment 2 being mounted to the cane main body 52 constituting the cane 51, the user grips the grip part 53 with one hand, for example, walking while contacting or leaving the bottom face of the slip stop rubber member 15 of the cane tip 1B with/from a supporting surface, the same function and advantages as those of the novel cane tip 1 and cane 51 in the aforementioned embodiment 1 can be obtained.

In addition, the novel cane tip 1B in accordance with the present embodiment 2 has six leg segments 3 each substantially in the shape of a rectangle, when viewed from the top, and thus even if the novel cane tip 1B is contacted with an inclined contact surface of the ground, or the like, the number of leg segments 3 being as many as six makes the novel cane tip 1B more difficult to slip, with the slip stop rubber member 15 and the rubber member 14 of the six leg segments 3 providing an individual elastic deformation to suppress the effect of the inclination more effectively, whereby a still more excellent walking stability can be provided than with the cane tip of five leg segments.

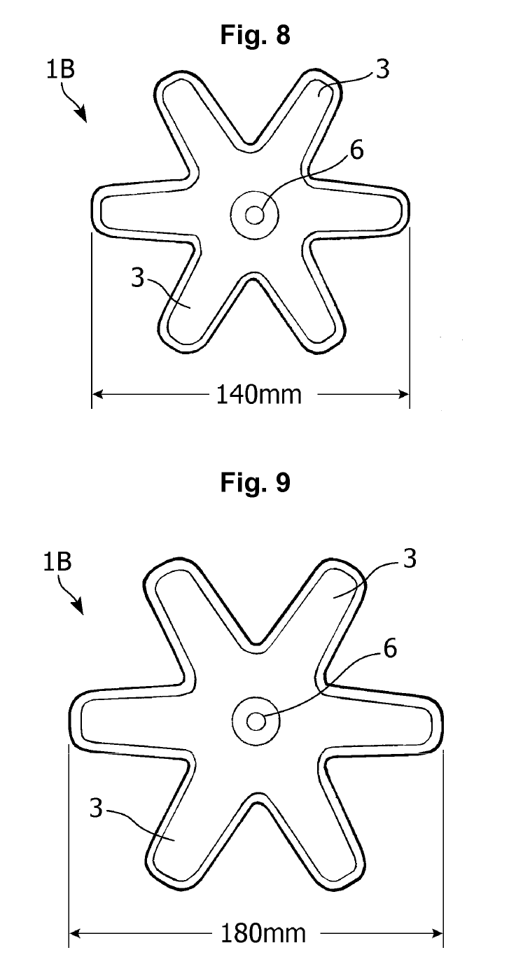

The novel cane tip 1B in accordance with the present embodiment 2 is applicable to single walking sticks and crutches, with the maximum dimension of the novel cane tip 1B, when viewed from the top, being designated, for example, to be 100 mm or approx. 100 mm as shown in FIG. 7; is applicable to Lofstrand crutches, with the maximum dimension of the novel cane tip 1B, when viewed from the top, being designated, for example, to be 140 mm or approx. 140 mm as shown in FIG. 8; and further, is applicable to four-legged canes and three-legged canes, with the maximum dimension of the novel cane tip 1B, when viewed from the top, being designated, for example, to be 180 mm or approx. 180 mm as shown in FIG. 9.

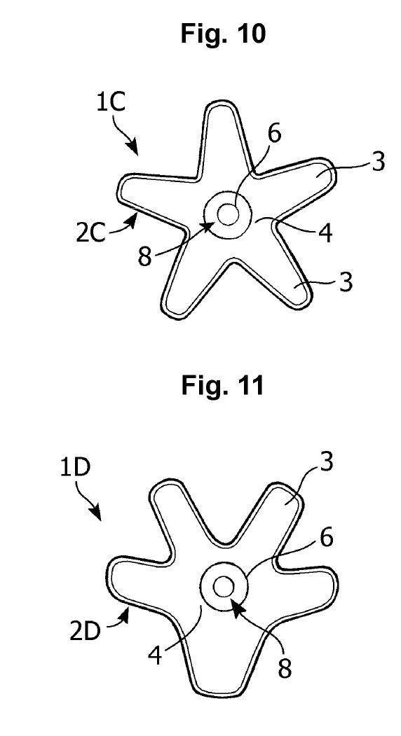

FIG. 10 shows a novel cane tip 1C, which is a modification of the cane tip 1B in accordance with the present embodiment 2.

The basic configuration of the novel cane tip 1C shown in the same figure is identical to that of the cane tip 1B in accordance with the embodiment 2, however, unlike the cane tip 1B, the cane tip 1C is provided with a cane tip main body 2C having five leg segments 3 arranged in an overall shape substantially analogous to that of, for example, the five legs of a five-legged starfish and radially extending outwards from a central part 4, each substantially in the shape of a tapered rectangle, when viewed from the top, the central part 4 and the each leg segment 3 having an elastic structure part 5 exerting an elastic action, and the cane tip 1C being in the shape of, for example, a profiled flat disk, as a whole, and having a wide area, as compared to the cane tip of the conventional cane.

As described above, in the present invention, the shape of the cane tip main body 2 is not limited to that of a profiled flat disk, and the cane tip main body 2 may also be in the shape of, for example, a reversed umbrella, substantially the central portion of the cane tip main body 2 forming the apex thereof. In addition, the cane tip main body 2 may be in the shape of, for example, a truncated cone, the central portion of the cane tip main body 2 forming the upper base of the truncated cone.

As described above, the elastic structure part 5 is not limited to the illustrated example, and in the present invention, it may also be implemented as such a structure as a single-layer rubber material structure, a laminated structure of a rubber material and a material other than rubber material, or the like.

As described above, in the present invention, the mounting and removing structure of the cane tip main body 2 and the tip part 52a of the cane main body 52 may also be implemented by forming a bolt portion in the tip part 52a of the cane main body 52, and providing a bolt inserting hole in the inside of the cane tip main body 2 to allow the bolt portion to be screwed or unscrewed, thereby making the cane tip main body 2 and the cane main body 52 mountable and removable to/from each other.

Also when, with this modification, i.e., the novel cane tip 1C, being mounted to the cane main body 52 constituting the cane 51, the user grips the grip part 53 with one hand, for example, walking while contacting or leaving the bottom face of the slip stop rubber member 15 of the novel cane tip 1C with/from a supporting surface, the same function and advantages as those of the novel cane tip 1B and cane 51 in the aforementioned embodiment 2 can be obtained.

The cane tip 1B in accordance with the present embodiment 2 and the cane tip 1C, which is a modification of the cane tip 1B, are applicable not only to single walking sticks, but also to multi-leg canes, Lofstrand crutches, crutches, folding canes, and the like.

### Embodiment 3

Next, with reference to FIG. 11, a novel cane tip 1D in accordance with an embodiment 3 of the present invention will be explained.

For the novel cane tip 1D shown in FIG. 11, the same elements as those of the novel cane tip 1 in the embodiment 1 will be provided with the same reference numerals, and the detailed explanation of them will be omitted.

As is the case with the embodiment 1, the novel cane tip 1D shown in FIG. 11 in accordance with the present embodiment 3 is used, being mounted to a cane main body 52 constituting a cane 51 in the form of a single walking stick, such as a T-shaped cane. The novel cane tip 1D is provided with a novel cane tip main body 2D having five leg segments 3 arranged in an overall shape substantially analogous to that of, for example, the four toes of a bird and radially extending outwards from a central part 4, each being substantially in the shape of a rectangle, when viewed from the top, the central part 4 and the each leg segment 3 having an elastic structure part 5 exerting an elastic action, and the cane tip 1D being in the shape of, for example, a profiled flat disk, as a whole, and having a wide area, as compared to the cane tip of the conventional cane.

As described above, in the present invention, the shape of the cane tip main body 2 is not limited to that of a profiled flat disk, and the cane tip main body 2 may also be in the shape of, for example, a reversed umbrella, substantially the central portion of the cane tip main body 2 forming the apex thereof. In addition, the cane tip main body 2 may be in the shape of, for example, a truncated cone, the central portion of the cane tip main body 2 forming the upper base of the truncated cone.

As described above, the elastic structure part 5 is not limited to the illustrated example, and in the present invention, it may also be implemented as such a structure as a single-layer rubber material structure, a laminated structure of a rubber material and a material other than rubber material, or the like.

As described above, in the present invention, the structure for mounting and removing of the cane tip main body 2 and the tip part 52a of the cane main body 52 may also be implemented by forming a bolt portion in the tip part 52a of the cane main body 52, and providing a bolt inserting hole in the inside of the cane tip main body 2 to allow the bolt portion to be screwed or unscrewed, thereby making the cane tip main body 2 and the cane main body 52 mountable and removable to/from each other.

In the present embodiment 3, the five leg segments 3 are unevenly arranged; four thereof being arranged so as to be biased towards one side (upward in FIG. 11) from the center as shown in FIG. 11, while the remaining one so as to protrude downward from the center.

Also when, with the novel cane tip 1D in the embodiment 3 being mounted to the cane main body 52 constituting the cane 51, the user grips the grip part 53 with one hand, for example, walking while contacting or leaving the bottom face of the slip stop rubber member 15 of the cane tip 1D with/from a supporting surface, substantially the same function and advantages as those of the novel cane tip 1 and cane 51 in the aforementioned embodiment 1 can be obtained, and although the five leg segments 3 are unevenly arranged, resulting in the walking stability being slightly lowered, this, on the contrary, makes the novel cane tip 1D well suited for use in rehabilitation as described later.

The novel cane tip 1D in accordance with the present embodiment 3 is applicable not only to single walking sticks, but also to multi-leg canes, Lofstrand crutches, crutches, folding canes, and the like.

### Embodiment 4

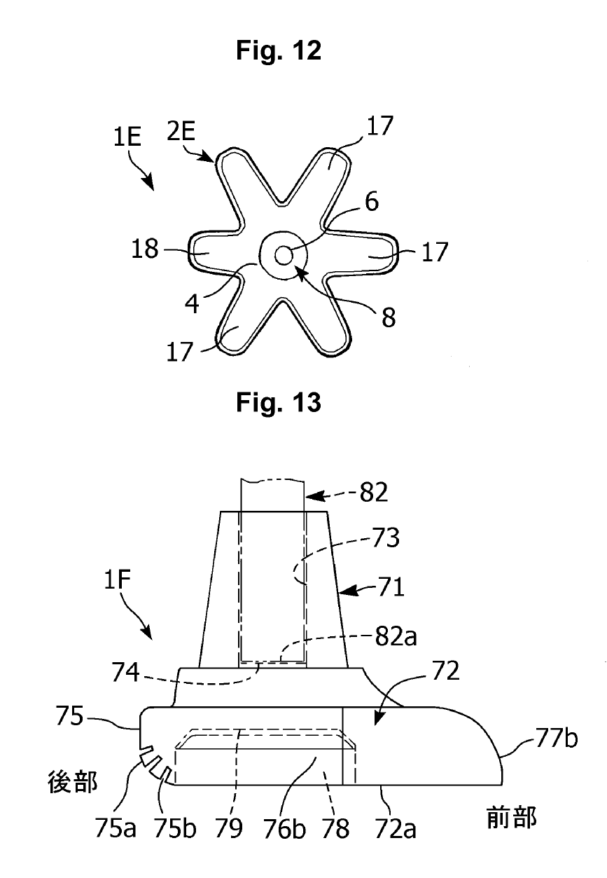

Next, with reference to FIG. 12, a novel cane tip 1E in accordance with an embodiment 4 of the present invention will be explained.

For the novel cane tip 1E shown in FIG. 12, the same elements as those of the novel cane tip 1 in the embodiment 1 will be provided with the same reference numerals, and the detailed explanation of them will be omitted.

As is the case with the embodiment 1, the novel cane tip 1E shown in FIG. 12 in accordance with the present embodiment 4 is used, being mounted to a cane main body 52 constituting a cane 51 in the form of a single walking stick, such as a T-shaped cane. The novel cane tip 1D is provided with a novel cane tip main body 2E in the shape of, for example, a profiled flat disk, as a whole, and has a wide area, as compared to the cane tip of the conventional cane, having six leg segments radially extending outwards from a central part 4, five of them being longer leg segments 17 with the same length, and one of them being a shorter leg segment 18 having a length shorter than the longer leg segment 17, with the central part 4 and the six leg segments having an elastic structure part 5 exerting an elastic action.

As described above, in the present invention, the shape of the cane tip main body 2 is not limited to that of a profiled flat disk, and the cane tip main body 2 may also be in the shape of, for example, a reversed umbrella, substantially the central portion of the cane tip main body 2 forming the apex thereof. In addition, the cane tip main body 2 may be in the shape of, for example, a truncated cone, the central portion of the cane tip main body 2 forming the upper base of the truncated cone.

As described above, the elastic structure part 5 is not limited to the illustrated example, and in the present invention, it may also be implemented as such a structure as a single-layer rubber material structure, a laminated structure of a rubber material and a material other than rubber material, or the like.

As described above, in the present invention, the mounting and removing structure of the cane tip main body 2 and the tip part 52a of the cane main body 52 may also be implemented by forming a bolt portion in the tip part 52a of the cane main body 52, and providing a bolt inserting hole in the inside of the cane tip main body 2 to allow the bolt portion to be screwed or unscrewed, thereby making the cane tip main body 2 and the cane main body 52 mountable and removable to/from each other.

Also when, with the novel cane tip 1E in the embodiment 4 being mounted to the cane main body 52 constituting the cane 51, the user grips the grip part 53 with one hand, for example, walking while contacting or leaving the bottom face of the slip stop rubber member 15 of the cane tip 1E with/from a supporting surface, substantially the same function and advantages as those of the novel cane tip 1 and cane 51 in the aforementioned embodiment 1 can be obtained, and although the six leg segments are designed to be non-uniform in length, thereby the walking stability being slightly lowered, this, on the contrary, makes the novel cane tip 1E well suited for use in rehabilitation as described later.

In addition, the six-leg segment configuration provides the five longer leg segments 17 having the same length, and the one leg segment 18 being shorter than the others, and thus if the user of the cane walks, orienting the shorter leg segment 18 in the same direction as that of walking, the walking stability will still be increased.

The novel cane tip 1E in accordance with the present embodiment 4 is applicable not only to single walking sticks, but also to multi-leg canes, Lofstrand crutches, crutches, folding canes, and the like.

In the case where the novel cane tip 1E in accordance with the present embodiment 4 is to be applied to crutches, Lofstrand crutches, or a multi-leg cane, it is advantageous to designate the maximum dimension of the novel cane tip 1E, when viewed from the top, to be, for example, 140 mm, 140 mm, or 180 mm, respectively.

Next, the specific form of service of the aforementioned novel cane tips 1A to 1E in accordance with the embodiment 1 to 4 of the present invention will be explained.

Any of the novel cane tips 1A to 1E can be easily mounted and removed to/from the cane main body 52 constituting the cane 51, and thus, in the case where the user, who is, for example, an old man/woman weak in arm strength or grip strength, a handicapped man/woman who is lame, or the like, is to walk, gripping the grip part 53 with one hand, the user can select and use the cane tip 1B in the embodiment 2, obtaining a still more excellent walking stability than can be obtained with any of the five-leg cane tips, whereby a satisfactory walking environment can be realized for the user.

In addition, a user who temporarily becomes difficult to walk due to an injury, or the like, can select and use an appropriate type of cane tip, depending upon the degree of recovery from the injury; for example, first can select and use the cane tip 1B in the embodiment 2, which can provide a still more excellent walking stability than can be obtained with any of the five-leg cane tips, and after a slight recovery having been obtained, can select and use, for example, the cane tip 1D or 1E in the embodiment 3, whereby rehabilitation in accordance with the degree of recovery of the physical strength of the user can be conveniently and effectively carried out.

### Embodiment 5

Next, with reference to FIG. 13 to FIG. 16, a novel cane tip 1F and cane 81 in accordance with an embodiment 5 of the present invention will be explained.

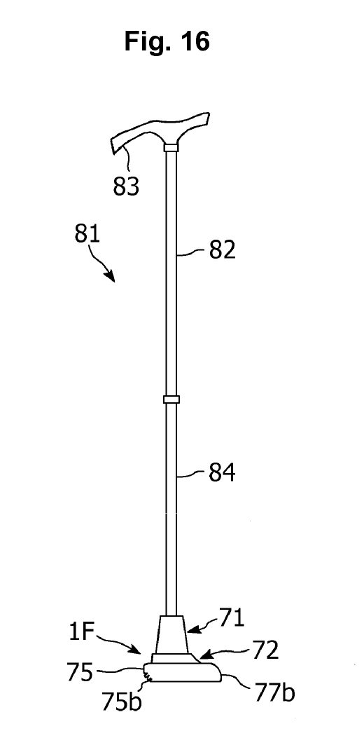

As is the case in the embodiment 1, the novel cane tip 1F in accordance with the present embodiment 5 is used, being mounted to a cane main body 82 constituting the cane 81 in the form of a single walking stick, such as a T-shaped cane, as shown in FIG. 16.

The cane 81 is provided with a grip part 83 at the upper end of the cane main body 82 for a user to grip it by hand, having a cylindrical shaft part 84, made of, for example, a stainless steel material and constituting the cane main body 82.

The overall length of the cane 81 in the state in which the cane tip 1F is mounted to the cane main body 82 is in the range of, for example, 700 to 800 mm, as is the case with the embodiment 1.

As shown in FIG. 13 to FIG. 15, the cane tip 1F in accordance with the present embodiment 5 includes a cane accommodating cylinder part 71 for accommodating a tip part 82a of the cane main body 82 of the cane 81, and a ground contacting body part 72 integrally provided under this cane accommodating cylinder part 71, and having a bottom face 72a formed flat to be contacted with a supporting surface, such as the ground, or the like, and having a wide area, as compared to the conventional cane tip.

The cane tip 1F comprised of an integral structure of the cane accommodating cylinder part 71 and the ground contacting body part 72 is formed as a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like, as in the embodiment 1; a single-layer rubber material structure; a laminated structure of a rubber material and a material other than rubber material, or the like.

The cane accommodating cylinder part 71 is configured such that the diameter is gradually reduced toward the top portion as is the case with a truncated cone, and is provided with a cane receiving bore part 73 having a bottom for accommodating the tip part 82a of the cane main body 82 inserted from the center of the upper end toward the bottom.

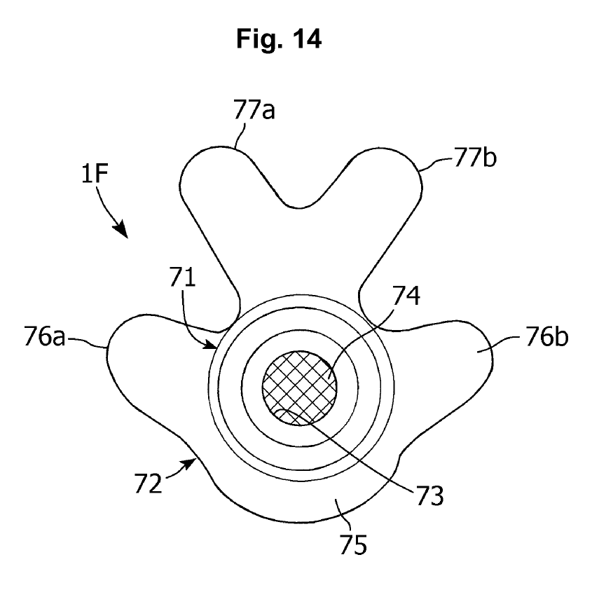

In addition, a reinforcing disk 74 formed of such a material as aluminum is disposed at the bottom of the cane receiving bore part 73, as shown with a cross-hatch pattern in FIG. 14, such that it is butted against the end face of the tip part 82a of the cane main body 82.

The ground contacting body part 72 is designed to be integral with the cane accommodating cylinder part 71 and, as shown in FIG. 13, which is an appearance side view, is configured such that they, as a whole, have a substantially shoe-like geometry when viewed from the side, the bottom face 72a being flat.

The cane accommodating cylinder part 71 designed to be integral with the ground contacting body part 72 is disposed, being shifted with respect to the ground contacting body part 72, rather than disposed in the central portion of the entire configuration of the cane tip 1F.

In other words, defining that, in FIG. 13, the left side of the cane tip 1F is the rear, while the right side of the cane tip 1F is the front, the center line of the cane receiving bore part 73 of the cane accommodating cylinder part 71 is disposed, being shifted toward the rear with respect to the ground contacting body part 72.

Further, the ground contacting body part 72 has a structure which has five leg segments protruded outwardly to be arranged in a decentralized manner in the outer edge portion thereof.

Specifically, as shown in FIG. 14, the leg segments are composed of a rear portion leg segment 75, which, as if it were the heel portion of a shoe, is protruded toward a rear portion of the ground contacting body part 72 beyond the area of the cane accommodating cylinder part 71, two side part leg segments 76a, 76b, which are protruded beyond the area of the cane accommodating cylinder part 71 toward both sides of the ground contacting body part 72, and two oblique leg segments 77a, 77b, which are protruded aslant rightward and aslant leftward on the front portion side of the ground contacting body part 72 beyond the area of the cane accommodating cylinder part 71, respectively, and when the cane tip 1F is viewed from the top, it exhibits an overall geometry substantially analogous to that of the toes of a bird. These leg segments form a curved contour in the protruded end region, the adjacent leg segments smoothly communicating with each other by their curved surfaces.

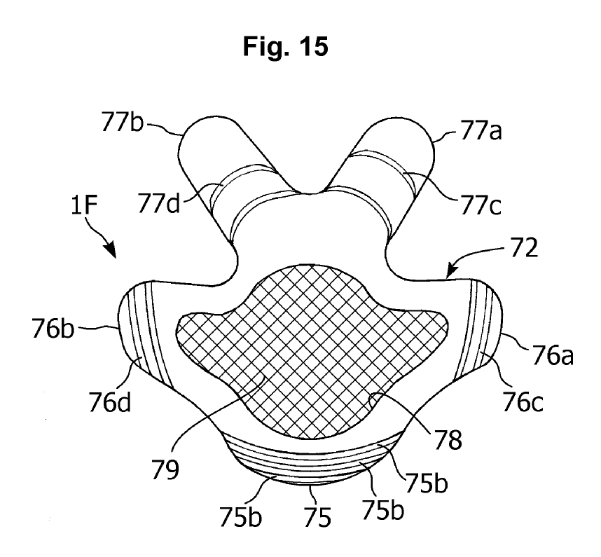

In the rear end portion of the rear portion leg segment 75, a curved face part 75a is partially formed as shown in FIG. 15, and in this curved face part 75a, three, for example, recess grooves 75b for slip stop in the shape of an arc are formed with a spacing being given between adjacent recess grooves. In addition, in the bottom face of the two side part leg segments 75a, 76b, two, for example, recess grooves 76c, 76d for slip stop in the shape of an arc are formed with a spacing being given between recess grooves.

Further, also in the bottom face of the two oblique leg segments 77a, 77b, two, for example, recess grooves 77c, 77d for slip stop in the shape of an arc, are formed with a spacing being given between recess grooves.

In the bottom face of the ground contacting body part 72, a recess part 78, which exerts a suction cup action, is provided, being disposed just under the cane accommodating cylinder part 71, with a depth in the range which does not reach the deepest portion of the cane accommodating cylinder part 71, and giving, for example, a deformed oval shape, when viewed from the bottom face.

To the internal bottom part of this recess part 78, a reinforcing member 79 formed of such a material as aluminum is applied as shown with a cross-hatch pattern in FIG. 15.

With such a structure of the bottom face of the ground contacting body part 72, the recess grooves 75b, recess grooves 76c, 76d and recess grooves 76c, 76d surround the recess part 78, although the surrounding is not made in a continuous manner.

Next, the function and advantages of the novel cane tip 1F and cane 81 in accordance with the present embodiment 5 will be explained.

When, with the cane tip 1F in accordance with the present embodiment 5 being mounted to the cane main body 82 constituting the cane 81, the user grips the grip part 83 with one hand, for example, walking while contacting or leaving the bottom face 72a of the ground contacting body part 72 of the cane tip 1F with/from a supporting surface, the cane tip 1F is difficult to slip even under such unfavorable road conditions as those on a rainy day, and the cane tip 1F exhibits excellent shock absorbing properties when contacted with the ground, or the like, because the entire bottom face 72a of the ground contacting body part 72 formed of a rubber material structure, for example, is contacted with a supporting surface; and the cane tip 1F has a wide area, as compared to the conventional one, whereby the walking stability is assured for any user, including an aged one.

Particularly, with the cane 81 loaded with the cane tip 1F in accordance with the present embodiment 5, the rear portion leg segment 75 of the ground contacting body part 72 is provided with the recess groove 75b for slip stop in the shape of an arc in a location likened to the heel portion of a shoe, and thus when the user walks, using the cane 81, and brings the rear portion leg segment 75 of the cane tip 1F into contact with a supporting surface for the first time, the recess groove 75b will be meshed with the supporting surface, if it is soft, the slip stop effect can be effectively exerted.

Further, in the case where the user walks, gripping the grip part 83 with one hand, under such unfavorable road conditions as those on a rainy day, the recess groove 75b can increase the contact friction with the supporting surface, whereby the walking stability of the user is improved.

The recess grooves 76c, 76d provided in the two side part leg segments 76a, 76b, and the recess grooves 77c, 77d provided in the two oblique leg segments 77a, 77b also exert the slip stop effect on the supporting surface and increase the contact friction with the supporting surface in the same manner as the recess grooves 75b in the rear portion leg segment 75, whereby the walking stability of the user can be improved.

Further, with the cane 81 loaded with the cane tip 1F in accordance with the present embodiment 5, the bottom face of the ground contacting body part 72 is provided with the recess part 78, and therefore, in the case where the supporting surface is smooth, for example, when the bottom face 72a around the recess part 78 is tightly contacted with the smooth supporting surface, the same function as that of a suction cup can be exerted, whereby the walking stability of the user can be improved.

In other words, according to the present embodiment 5, there can be realized and provided the novel cane tip 1F and the novel cane 81 using this cane tip 1F, which is difficult to slip, providing excellent shock absorbing properties when contacted with the ground, or the like; with which the recess grooves 75a, the recess grooves 76c, 76d, and the recess grooves 77c, 77d provided in the bottom face portion of the cane tip 1F can exert the slip stop effect on the supporting surface; and further, the recess part 78 provided in the bottom part of the ground contacting body part 72 can exert the same function as that of a suction cup, whereby the walking stability is assured for any user, including an aged one.

The various forms of novel cane tips in accordance with the present invention is widely applicable to single walking sticks, multi-leg canes, Lofstrand crutches, crutches, folding canes, and the like.

1. A cane tip, comprising:
a cane tip main body including a plurality of leg segments radially extending outwards from a central part thereof, the central part and each of the leg segments being provided with an elastic structure part exerting an elastic action; and
a mounting part provided in the central part of the cane tip main body for making the cane tip main body mountable and removable to/from a tip part of a cane main body.

2. A cane tip, comprising:
a cane tip main body including a plurality of leg segments arranged in an overall shape substantially analogous to that of the plural petals of a multi-petaled flower, the plural legs of a starfish, or the plural toes of a bird, and radially extending outwards from a central part thereof, the central part and each leg segment having an elastic structure part exerting an elastic action; and
a mounting part provided in the central part of the cane tip main body for making the cane tip main body mountable and removable to/from a tip part of a cane main body.

3. A cane tip, comprising:
a cane tip main body including a plurality of leg segments arranged in an overall shape substantially analogous to that of the five petals of a five-petaled flower, the five legs of a five-legged starfish, the six legs of a six-legged starfish, or the four toes of a bird, and radially extending outwards from a central part thereof, the central part and each leg segment having an elastic structure part exerting an elastic action; and
a mounting part provided in the central part of the cane tip main body for making the cane tip main body mountable and removable to/from a tip part of a cane main body.

4. A cane tip, comprising:
a cane tip main body including six leg segments constituted by five longer leg segments of the same length and one shorter leg segment formed shorter than the longer leg segment, and radially extending outwards from a central part thereof, the central part and each leg segment having an elastic structure part exerting an elastic action; and
a mounting part provided in the central part of the cane tip main body for making the cane tip main body mountable and removable to/from a tip part of a cane main body.

5. The cane tip of claim 1, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface.

6. (canceled)

7. The cane tip of claim 1, wherein the cane tip main body is in the shape of a profiled flat disk or in the shape of a reversed umbrella, substantially the central portion of the cane tip main body forming the apex thereof.

8. The cane tip of claim 1, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface; and the mounting part has a bolt inserting hole penetrating through the central part of the plate-shaped rubber member, plate-shaped glass carbon member, and plate-shaped wood member, and a bolt inserted into the bolt inserting hole to be anchored, a thread part thereof being protruded from the central part of the elastic structure part to be screwed or unscrewed into/from a receiving screw part provided inside of the tip part of the cane main body for making the cane tip main body mountable and removable to/from the tip part of the cane main body.

9-16. (canceled)

17. A cane tip, comprising:
a cane accommodating cylinder part in the shape of a truncated cone for accommodating a tip part of a cane main body;
a ground contacting body part provided integrally with the cane accommodating cylinder part, being located thereunder, such that the cane accommodating cylinder part is located biased towards one side, a plurality of segments being protruded to be arranged distributed in the outer edge portion of the ground contacting body part, the entire bottom face thereof being made flat; and
recess grooves for slip stop provided in the bottom face of at least one leg segment among the plurality of leg segments that is located on the same side as that on which the cane accommodating cylinder part is located biased.

18. A cane tip, comprising:
a cane accommodating cylinder part in the shape of a truncated cone for accommodating a tip part of a cane main body;
a ground contacting body part exhibiting substantially a shoe-like geometry, being provided integrally with the cane accommodating cylinder part such that the cane accommodating cylinder part is located biased toward a rear portion of the ground contacting body part likened to the heel portion of a shoe, having leg segments arranged distributed in the outer edge portion of the ground contacting body part, the leg segments including a rear leg segment protruded toward the rear portion of the ground contacting body part likened to the heel portion of a shoe, a side leg segment protruded toward a side of the ground contacting body part, and an oblique leg segment protruded aslant forward on the front part side of the ground contacting body part, and the entire bottom face thereof being made flat; and
recess grooves for slip stop provided in the respective bottom faces of the rear leg segment, side leg segment, and oblique leg segment.

19. A cane tip, comprising:
a cane accommodating cylinder part in the shape of a truncated cone for accommodating a tip part of a cane main body;
a ground contacting body part exhibiting substantially a shoe-like geometry, being provided integrally with the cane accommodating cylinder part such that the cane accommodating cylinder part is located biased toward a rear portion of the ground contacting body part likened to the heel portion of a shoe, having five leg segments arranged distributed in the outer edge portion thereof, the leg segments including a rear leg segment protruded toward the rear portion thereof likened to the heel portion of a shoe, two side leg segments protruded toward both sides thereof, and two oblique leg segments protruded aslant rightward and leftward on the front part side thereof, the overall shape of the leg segments being substantially analogous to that of the toes of a bird, and the entire bottom face thereof being made flat;
recess grooves for slip stop provided in the respective bottom faces of the rear leg segment, side leg segment, and oblique leg segment; and
a recess part exerting the suction function, being provided inward from the bottom face of the ground contacting body part.

20. The cane tip of claim 17, wherein the cane accommodating cylinder part and ground contacting body part constituting the cane tip are comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

21-25. (canceled)

26. The cane tip of claim 2, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface.

27. The cane tip of claim 3, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface.

28. The cane tip of claim 4, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface.

29. The cane tip of claim 2, wherein the cane tip main body is in the shape of a profiled flat disk or in the shape of a reversed umbrella, substantially the central portion of the cane tip main body forming the apex thereof.

30. The cane tip of claim 3, wherein the cane tip main body is in the shape of a profiled flat disk or in the shape of a reversed umbrella, substantially the central portion of the cane tip main body forming the apex thereof.

31. The cane tip of claim 4, wherein the cane tip main body is in the shape of a profiled flat disk or in the shape of a reversed umbrella, substantially the central portion of the cane tip main body forming the apex thereof.

32. The cane tip of claim 5, wherein the cane tip main body is in the shape of a profiled flat disk or in the shape of a reversed umbrella, substantially the central portion of the cane tip main body forming the apex thereof.

33. The cane tip of claim 2, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface; and the mounting part has a bolt inserting hole penetrating through the central part of the plate-shaped rubber member, plate-shaped glass carbon member, and plate-shaped wood member, and a bolt inserted into the bolt inserting hole to be anchored, a thread part thereof being protruded from the central part of the elastic structure part to be screwed or unscrewed into/from a receiving screw part provided inside of the tip part of the cane main body for making the cane tip main body mountable and removable to/from the tip part of the cane main body.

34. The cane tip of claim 3, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface; and the mounting part has a bolt inserting hole penetrating through the central part of the plate-shaped rubber member, plate-shaped glass carbon member, and plate-shaped wood member, and a bolt inserted into the bolt inserting hole to be anchored, a thread part thereof being protruded from the central part of the elastic structure part to be screwed or unscrewed into/from a receiving screw part provided inside of the tip part of the cane main body for making the cane tip main body mountable and removable to/from the tip part of the cane main body.

35. The cane tip of claim 4, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface; and the mounting part has a bolt inserting hole penetrating through the central part of the plate-shaped rubber member, plate-shaped glass carbon member, and plate-shaped wood member, and a bolt inserted into the bolt inserting hole to be anchored, a thread part thereof being protruded from the central part of the elastic structure part to be screwed or unscrewed into/from a receiving screw part provided inside of the tip part of the cane main body for making the cane tip main body mountable and removable to/from the tip part of the cane main body.

36. The cane tip of claim 5, wherein the elastic structure part is formed of a laminated structure constituted by a plate-shaped wood member covered with a covering layer formed of urethane resin, a plate-shaped glass carbon member, a plate-shaped rubber member, and a plate-shaped slip stop rubber member provided with a concavoconvex part as a lower end face to be contacted with a supporting surface, these being arranged in this order from the upper portion toward the lower portion to be contacted with a supporting surface; and the mounting part has a bolt inserting hole penetrating through the central part of the plate-shaped rubber member, plate-shaped glass carbon member, and plate-shaped wood member, and a bolt inserted into the bolt inserting hole to be anchored, a thread part thereof being protruded from the central part of the elastic structure part to be screwed or unscrewed into/from a receiving screw part provided inside of the tip part of the cane main body for making the cane tip main body mountable and removable to/from the tip part of the cane main body.

37. The cane tip of claim 18, wherein the cane accommodating cylinder part and ground contacting body part constituting the cane tip are comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

38. The cane tip of claim 19, wherein the cane accommodating cylinder part and ground contacting body part constituting the cane tip are comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

39. A cane comprising a cane main body and the cane tip of claim 17.

40. A cane comprising a cane main body and the cane tip of claim 18.

41. A cane comprising a cane main body and the cane tip of claim 19.

42. The cane of claim 39, wherein the cane accommodating cylinder part and ground contacting body part constituting the cane tip are comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

43. The cane of claim 40, wherein the cane accommodating cylinder part and ground contacting body part constituting the cane tip are comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

44. The cane of claim 41, wherein the cane accommodating cylinder part and ground contacting body part constituting the cane tip are comprised of a single-layer rubber material structure; a laminated structure, such as that constituted by a plate-shaped wood member formed of, for example, laminated wood covered with a covering layer formed of urethane resin, a plate-shaped glass carbon member, a plate-shaped rubber member formed of high-pressure rubber, and the like; or a laminated structure of a rubber material and a material other than rubber material.

45. The cane of claim 39, wherein the cane main body constituting the cane is in a form selected from those of a single walking stick, a multi-leg cane, Lofstrand crutches, a folding cane, and crutches.

46. The cane of claim 40, wherein the cane main body constituting the cane is in a form selected from those of a single walking stick, a multi-leg cane, Lofstrand crutches, a folding cane, and crutches.

47. The cane of claim 41, wherein the cane main body constituting the cane is in a form selected from those of a single walking stick, a multi-leg cane, Lofstrand crutches, a folding cane, and crutches.

48. The cane of claim 42, wherein the cane main body constituting the cane is in a form selected from those of a single walking stick, a multi-leg cane, Lofstrand crutches, a folding cane, and crutches.
